(19) United States
(12) Patent Application Publication
(10) Pub. No.: US 2011/0303737 A1
(43) Pub. Date: Dec. 15, 2011

(54) JET SOLDERING DEVICE AND SOLDERING METHOD

(75) Inventors: Toshinori Mimura, Osaka (JP); Hiroshi Yamauchi, Osaka (JP); Shinji Yoshino, Hyogo (JP)

(73) Assignee: PANASONIC CORPORATION, Osaka (JP)

(21) Appl. No.: 13/202,905

(22) PCT Filed: Jun. 4, 2010
(86) PCT No.: PCT/JP2010/003728

§ 371 Date: Aug. 23, 2011

(30) Foreign Application Priority Data
Jun. 4, 2009 (JP) 2009-134557

(51) Int. Cl. B23K 1/20; B23K 3/06

(52) U.S. Cl. 228/260; 228/33

(57) ABSTRACT

A jet soldering device of the present invention includes: a solder bath (11) containing melted solder; a jet nozzle (15) that includes an end face for ejecting the melted solder, a cutout (30) provided on the end face, and a recovery wall (32) provided on the end face; a solder feeding mechanism (13, 20, 21, 22) that feeds the melted solder contained in the solder bath (11) to the jet nozzle (15); a tank moving mechanism (23, 24, 25, 26) that moves the solder bath (11); a solder receiving wall (42) that surrounds the jet nozzle (15) with a predetermined clearance and is connected to the jet nozzle (15); and a rotating mechanism (44, 45, 46) that transmits a drive force from the outside of the solder receiving wall (42) to rotate the solder receiving wall (42) and the jet nozzle (15).

### TECHNICAL FIELD

The present invention relates to a jet soldering device and a soldering method by which a soldering component is soldered to a soldering object with melted solder locally contacted with the soldering object.

### BACKGROUND ART

A jet soldering device of the related art will be described below in accordance with the accompanying drawings. FIG. 12 is a schematic diagram showing the configuration of the jet soldering device according to the related art.

As shown in FIG. 12, a solder bath 1 contains melted solder 2. The solder in the solder bath 1 can be melted by heating the solder bath 1. The melted solder 2 in the solder bath 1 can be kept at a constant temperature by controlling the heating temperature of the solder bath 1.

In the solder bath 1, a propeller 3 and a solder feeding path 4 are provided. The propeller 3 is disposed on one end of the solder feeding path 4. The melted solder 2 is pumped through the solder feeding path 4 by the rotating propeller 3. The propeller 3 is rotated by a drive unit 5 provided outside the solder bath 1.

A jet nozzle 6 protruding upward from the solder bath 1 is connected to another end of the solder feeding path 4. The pumped melted solder 2 is ejected with a constant height from the end face of the jet nozzle 6. The melted solder 2 ejected from the end face of the jet nozzle 6 is locally brought into contact with a printed circuit board 7 transported above the solder bath 1 by a printed circuit board transport unit 9. Thus leads 8 of an electronic component are soldered to the electrodes of the printed circuit board 7.

Specifically, the electronic component (not shown) is mounted on one surface of the printed circuit board 7, the leads 8 of the electronic component are inserted into through holes (not shown) formed on the printed circuit board 7, and the leads 8 are partially protruded from another surface of the printed circuit board 7. The melted solder 2 comes into contact with the surface where the leads 8 are partially protruded. Hereinafter, the surface where the leads of the electronic component are protruded from the through holes will be called a soldering surface. The melted solder 2 is locally brought into contact with the soldering surface, so that the leads 8 of the electronic component are soldered to the electrodes (not shown) formed on the soldering surface of the printed circuit board 7. In soldering, an excessive amount of the melted solder 2 ejected from the jet nozzle 6 is collected into the solder bath 1 through the sides of the jet nozzle 6.

Typically, the jet nozzle 6 has a circular opening. The diameter of the opening of the jet nozzle 6 is selected from a range of 5 mm to 12 mm according to, for example, the thermal capacity of a point to be soldered or a clearance between adjacent electronic components. Patent Literature 1 describes the jet nozzle 6 having an oval opening 10 as shown in FIG. 13.

Patent Literature 2 describes a soldering device that controls the contact position of melted solder by means of a robot having a holding mechanism for holding a printed circuit board. Hereinafter, a position brought into contact with the melted solder will be called a soldering position.

In the case where points to be soldered are adjacent to each other, so-called “drag soldering” is performed. Hereinafter, a point to be soldered will be called a soldering point. In drag soldering, first, the melted solder 2 ejected from the jet nozzle 6 is brought into contact with one of the adjacent soldering points. After that, the printed circuit board 7 is moved in parallel with the array of the adjacent soldering points.

In drag soldering by the jet soldering device of the related art, however, the melted solder 2 applied to a soldering point may be pulled depending upon the surface tension of the melted solder 2 even after the soldering point passes over the jet nozzle 6, leaving an excessive amount of the melted solder 2 hanging from the soldering point. An excessive amount of the melted solder 2 may cause faulty soldering, e.g., so-called “solder bridging” and “solder protrusion”. These phenomena are highly likely to occur when a soldering point has a large thermal capacity. A soldering component having a large thermal capacity is, for example, a sheet metal shield. Solder bridging is a state in which adjacent soldering points are electrically connected by soldering. Solder protrusion is solidification of solder hanging from a soldering point.

### CITATION LIST

### Patent Literatures

Patent Literature 1: Japanese Patent Laid-Open No. 2007-134609
Patent Literature 2: Japanese Patent Laid-Open No. 9-199844

### SUMMARY OF INVENTION

### Technical Problem

An object of the present invention is, in view of the problem described above, to provide a jet soldering device and a soldering method which can reduce the occurrence of faulty soldering such as solder bridging and solder protrusion.

### Solution to Problem

In order to attain the object, a jet soldering device of the present invention includes:

a solder bath containing melted solder;

a jet nozzle that includes a side, an end face for ejecting the melted solder, a cutout provided on the end face to allow the passage of the melted solder from the end face, and a recovery wall provided on the end face to partially collect the melted solder having been applied to at least one of a soldering object and a soldering component to be soldered to the soldering object;

a solder feeding mechanism that feeds the melted solder contained in the solder bath to the jet nozzle;

a tank driving mechanism that moves the solder bath;

a solder receiving wall that surrounds the jet nozzle with a predetermined clearance and is connected to the jet nozzle; and

a rotating mechanism that transmits a drive force to the solder receiving wall from the outside of the solder receiving wall to rotate the solder receiving wall and the adsorption nozzle connected to the solder receiving wall.

According to another aspect of the present invention, in the jet soldering device of the present invention, the tank moving mechanism moves the solder bath or the rotating mechanism rotates the adsorption nozzle while the tank moving mechanism moves the solder bath, in order to set the relative movement direction of the jet nozzle and the soldering object within a range of ±90° with respect to the flowing direction of the melted solder from the end face of the jet nozzle.

According to still another aspect of the present invention, in the jet soldering device of the present invention, the side of the jet nozzle includes a groove provided under the cutout as the passage of the melted solder.

According to still another aspect of the present invention, in the jet soldering device of the present invention, the side of the jet nozzle has a portion under the cutout of the jet nozzle such that the portion is made of a material having higher wettability to the melted solder than other parts of the side.

According to still another aspect of the present invention, the jet soldering device of the present invention further includes a solder attracting member covering a portion under the cutout on the side of the jet nozzle, the solder attracting member having a surface made of a material having higher wettability to the melted solder than the side of the jet nozzle.

According to still another aspect of the present invention, in the jet soldering device of the present invention, the end face of the jet nozzle includes a groove provided as the passage of the melted solder.

According to still another aspect of the present invention, the jet soldering device of the present invention further includes a measuring device that measures an amount of warpage of the soldering object, wherein the tank moving mechanism adjusts a height from an end of the jet nozzle to the soldering object according to the amount of warpage measured by the measuring device.

According to still another aspect of the present invention, the jet soldering device of the present invention further includes an updatable library in which soldering conditions are registered for each soldering component type.

A soldering method of the present invention is a soldering method of feeding melted solder from a solder bath to a jet nozzle and locally bringing a soldering object into contact with the melted solder ejected from the end face of the jet nozzle,

the jet nozzle including a side, the end face for ejecting the melted solder, a cutout provided on the end face to allow the passage of the melted solder from the end face, and a recovery wall provided on the end face to partially collect the melted solder having been applied to at least one of the soldering object and a soldering component to be soldered to the soldering object,

in soldering on the soldering object and the soldering component, the soldering method including:

moving the solder bath by a tank moving mechanism or rotating the adsorption nozzle by a rotating mechanism while the tank moving mechanism moves the solder bath, in order to set the relative movement direction of the jet nozzle and the soldering object within a range of ±90° with respect to the flowing direction of the melted solder from the end face of the jet nozzle.

According to another aspect of the present invention, in the soldering method of the present invention, in soldering on the soldering object and the soldering component, the tank moving mechanism moves the solder bath or the rotating mechanism rotates the adsorption nozzle while the tank moving mechanism moves the solder bath, in order to move the jet nozzle in the flowing direction of the melted solder from the end face of the jet nozzle.

### Advantageous Effects of Invention

A preferred embodiment of the present invention can reduce the occurrence of faulty soldering such as solder bridging and solder protrusion.

### BRIEF DESCRIPTION OF THE DRAWINGS

FIG. 1 is a schematic diagram showing a structural example of a jet soldering device according to an embodiment of the present invention.

FIG. 2A is a partial enlarged view showing an example of a jet nozzle according to the embodiment of the present invention.

FIG. 2B is a partial enlarged view showing another example of the jet nozzle according to the embodiment of the present invention.

FIG. 2C is a partial enlarged view showing still another example of the jet nozzle according to the embodiment of the present invention.

FIG. 2D is a partial enlarged view showing still another example of the jet nozzle according to the embodiment of the present invention.

FIG. 3 shows a solder attracting member according to the embodiment of the present invention.

FIG. 4A shows the measurement values of the ejection heights of melted solder when the jet nozzle is used according to the embodiment of the present invention.

FIG. 4B shows the measurement values of the ejection heights of melted solder when a typical jet nozzle is used.

FIG. 5 shows an example of an ejection height measurement method of melted solder according to the embodiment of the present invention.

FIG. 6A shows a soldering state in which drag soldering is performed using the jet nozzle according to the embodiment of the present invention.

FIG. 6B shows a soldering state in which drag soldering is performed using a typical jet nozzle.

FIG. 7 is a cross-sectional view showing an example of a configuration for fastening the jet nozzle and a solder receiving wall according to the embodiment of the present invention.

FIG. 8A is an explanatory drawing showing an example of the layout of a substrate warpage measuring device according to the embodiment of the present invention.

FIG. 8B is an explanatory drawing showing another example of the layout of the substrate warpage measuring device according to the embodiment of the present invention.

FIG. 9 shows an example of the process flow of the jet soldering device according to the embodiment of the present invention.

FIG. 10 shows an example of a library of the jet soldering device according to the embodiment of the present invention.

FIG. 11A shows an example of the moving directions of the jet nozzle and the orientations of the cutout of the jet nozzle according to the embodiment of the present invention.

FIG. 11B shows X position, Y position, and Z position of the jet nozzle and an angle of the cutout of the jet nozzle according to FIG. 11A.

FIG. 12 is a schematic diagram showing the configuration of a jet soldering device according to the related art.

FIG. 13 is a partial enlarged view showing a jet nozzle according to the related art.

### DESCRIPTION OF EMBODIMENTS

An embodiment of a jet soldering device and a soldering method of the present invention will be described below in accordance with the accompanying drawings. The same elements as in the explanation are indicated by the same reference numerals and an explanation thereof may be optionally omitted. As a matter of course, the present invention is not limited to the following embodiment.

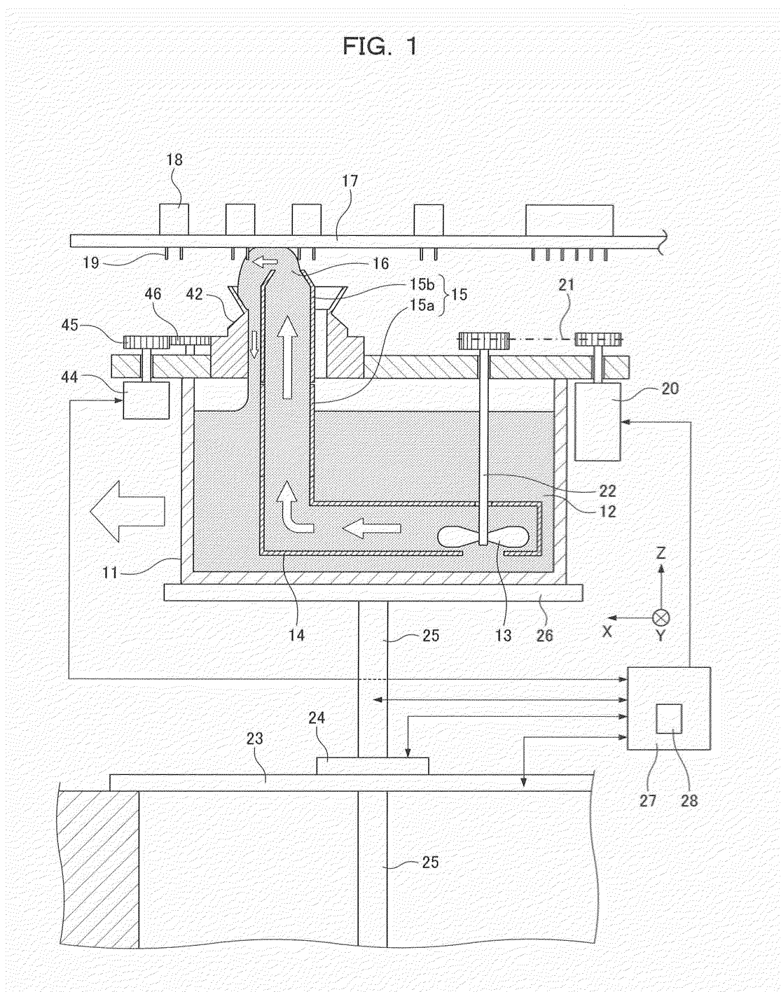

FIG. 1 is a schematic diagram showing a structural example of the jet soldering device according to the embodiment of the present invention. In the present embodiment, a soldering object is a printed circuit board having through holes, and a soldering component soldered to the soldering object is an electronic component having leads. The soldering object and the soldering component are not limited to the printed circuit board and the electronic component.

As shown in FIG. 1, a solder bath 11 contains melted solder 12. Solder in the solder bath 11 can be melted by heating the solder bath 11. The melted solder 12 in the solder bath 11 can be kept at a constant temperature by controlling the heating temperature of the solder bath 11.

In the solder bath 11, a propeller 13 and a solder feeding path 14 are provided. The propeller 13 is disposed on one end of the solder feeding path 14. The melted solder 12 is pumped through the solder feeding path 14 by the rotating propeller 13.

A jet nozzle 15 protruding upward from the solder bath 11 is connected to another end of the solder feeding path 14. The pumped melted solder 12 is ejected with a constant height from an opening 16 provided on the end face of the jet nozzle 15. The melted solder 12 ejected from the end face of the jet nozzle 15 is locally brought into contact with a printed circuit board 17. Thus leads 19 of an electronic component 18 are soldered to the electrodes (not shown) of the printed circuit board 17.

Specifically, the electronic component 18 is mounted on one surface of the printed circuit board 17, the leads 19 of the electronic component 18 are inserted into through holes (not shown) formed on the printed circuit board 17, and the leads 19 are partially protruded from the soldering surface of the printed circuit board 17. The melted solder 12 locally comes into contact with the soldering surface of the printed circuit board 17. Thus the leads 19 of the electronic component are soldered to the electrodes (not shown) formed on the soldering surface of the printed circuit board 17.

The propeller 13 for pumping the melted solder 12 is rotated by a motor 20 disposed outside the solder bath 11. In the present embodiment, the motor 20 applies a drive force to a shaft 22 via a chain 21. The shaft 22 is connected to the center of the propeller 13. In the present embodiment, the propeller 13, the motor 20, the chain 21, and the shaft 22 constitute a solder feeding mechanism that feeds the melted solder 12 in the solder bath 11 to the jet nozzle 15.

The jet soldering device further includes a tank moving mechanism that moves the solder bath 11 relative to the printed circuit board 17. The tank moving mechanism controls a soldering position. In the present embodiment, the tank moving mechanism includes: a first moving unit 23 that is driven in a first direction; a second moving unit 24 that is disposed on the first moving unit 23 and is driven in a second direction crossing the first direction; a lifting unit 25 that is supported at least by the second moving unit 24 so as to move in the vertical direction; and a setting table 26 connected to the lifting unit 25. The solder bath 11 is placed on the setting table 26. In the present embodiment, the solder bath 11 moves in X, Y, and Z directions that are orthogonal to one another. To be specific, the first moving unit 23 moves in the Y direction, that is, in the depth direction in the plane of FIG. 1. The second moving unit 24 moves in the X direction, that is, in the horizontal direction in the plane of FIG. 1. The lifting unit 25 moves up or down in the Z direction, that is, in the vertical direction in the plane of FIG. 1.

As will be described later, the jet soldering device includes a nozzle rotating mechanism that rotates the jet nozzle 15 with respect to the printed circuit board 17 and a substrate warpage measuring device that measures an amount of warpage of the printed circuit board 17.

The operations of the overall jet soldering device are controlled by a control unit 27. The control unit 27 includes a storage part 28 that stores soldering programs for controlling the operations of the overall jet soldering device. The storage part 28 includes, for example, libraries used for generating soldering programs.

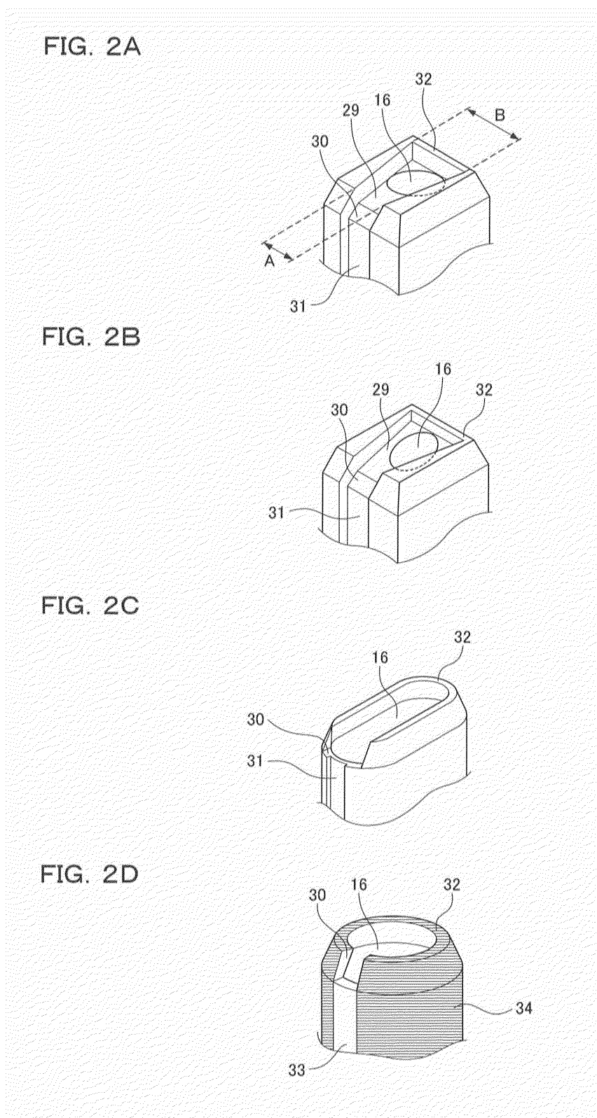

The following will specifically describe the jet nozzle 15 of the present embodiment. FIG. 2A is an enlarged view showing an example of the jet nozzle according to the embodiment of the present invention.

As shown in FIG. 2A, the end face of the jet nozzle 15 includes the opening 16 for ejecting the melted solder 12, a first groove 29, and a cutout 30. The opening 16 is formed in the first groove 29. The cutout 30 is connected to the first groove 29. Thus the melted solder 12 flowing from the end face of the jet nozzle 15 flows to a side of the jet nozzle 15 through the cutout 30. Under the cutout 30 on the side of the jet nozzle 15, a second groove 31 is formed. The second groove 31 is connected to the cutout 30 and thus the melted solder 12 flowing to the side of the jet nozzle 15 passes through the second groove 31.

On the jet nozzle 15 of FIG. 2A, the first groove 29, the cutout 30, and the second groove 31 constitute a passage that specifies the flowing direction of the melted solder 12. An excessive amount of the melted solder 12 in soldering passes through the passage and is collected into the solder bath 11.

On the end face of the jet nozzle 15, a recovery wall 32 is provided to quickly collect an excessive amount of the melted solder 12 on the printed circuit board 17 and/or the leads 19 of the electronic component. In this configuration, the recovery wail 32 is the entire wall of the passage composed of the first groove 29 and the cutout 30.

The opening 16 of the jet nozzle has to be large enough in diameter to eject the melted solder 12. For example, the diameter of the opening 16 of the jet nozzle is set at about 5 mm. Furthermore, the passage that specifies the flowing direction of the melted solder 12 has to be large enough in width and depth to always collect an excessive amount of the melted solder 12 in the solder bath 11 through the passage. For example, the width of the passage is set at about 5 mm and the depth of the passage is set at about 2 mm to 3 mm.

The height of the melted solder 12 ejected from the end face of the jet nozzle 15 can be adjusted by controlling the number of revolutions of the propeller 13. For example, the number of revolutions of the propeller 13 is set so as to eject the melted solder 12 with a height of about 3 mm to 4 mm from the end face of the jet nozzle 15. Hereinafter, the height of the melted solder 12 ejected from the jet nozzle 15 will be referred to as a solder ejection height.

The melted solder 12 is vertically ejected from the opening 16 of the jet nozzle and then passes through the passage provided on the jet nozzle 15. Thus a solder ejection height around the cutout 30 tends to be lower than that around the opening 16. To eliminate the height difference, the first groove 29 provided on the end face of the jet nozzle 15 is reduced in width with the increasing distance from the opening 16. Thus the solder ejection height can be equalized. For example, width B of the first groove 29 around the opening 16 is set at 5 mm and width A of the first groove 29 around the cutout 24 is set at 4 mm.

Moreover, a curved surface may be provided on a joint portion between the first groove 29 provided on the end face of the jet nozzle 15 and the second groove 31 provided on the side of the jet nozzle 15, that is, on the bottom of the cutout 30. This configuration allows the melted solder 12 to stably flow through the passage provided on the jet nozzle 15. Alternatively, as shown in FIG. 2B, the bottom of the first groove 29 may be tilted downward along the flowing direction of the melted solder 12. This configuration also allows the melted solder 12 to stably flow through the passage provided on the jet nozzle 15. The tilt angle can be set at, for example, about 45°.

The thermal capacity of the jet nozzle 15 considerably affects solderability. The thermal capacity of the jet nozzle 15 has to be sufficiently large relative to the thermal capacity of a soldering point. The thermal capacity of the jet nozzle 15 is determined by the size of the passage provided on the jet nozzle 15 and the amount of the melted solder 12 supplied to the jet nozzle 15. Thus it is necessary to select the size of the passage provided on the jet nozzle 15 and the size of the opening 16 of the jet nozzle in consideration of, for example, the thermal capacity of the soldering point and a clearance between adjacent soldering components.

The following will describe another example of the jet nozzle as shown in FIG. 2C. In the jet nozzle 15 of FIG. 2C, the oval opening 16 is provided substantially over the end face of the jet nozzle 15.

The cutout 30 of the jet nozzle 15 is provided on one semicircular end of the end-face edge of the jet nozzle 15. Under the cutout 3Q on the side of the jet nozzle 15, the groove 31 is provided. The groove 31 is connected to the cutout 30. On the jet nozzle 15, the cutout 30 and the groove 31 constitute a passage of the melted solder 12. The provision of the passage can specify the flowing direction of the melted solder 12. Furthermore, the melted solder 12 does not spread larger than the width of the jet nozzle 15, enabling soldering in a narrow space. The width of the cutout 30 can be set at, for example, about 5 mm. The width of the groove 31 can be set at, for example, about 5 mm and the depth of the groove 31 can be set at, for example, about 2 mm.

On the jet nozzle 15, a portion other than the cutout 30 serves as the recovery wall 32 on the end-face edge of the jet nozzle 15.

The following will describe still another example of the jet nozzle as shown in FIG. 2D. In the jet nozzle 15 of FIG. 2D, the circular opening 16 is provided substantially over the end face of the jet nozzle 15.

The cutout 30 of the jet nozzle 15 is provided on a part of the end-face edge of the jet nozzle 15. The width of the cutout 30 can be set at, for example, about 5 mm and the depth of the cutout 30 can be set at, for example, about 2 mm.

On the jet nozzle 15, a portion other than the cutout 30 serves as the recovery wall 32 on the end-face edge of the jet nozzle 15.

Moreover, a lower portion 33 of the cutout 30 on the side of the jet nozzle 15 is made of a material having higher wettability to the melted solder 12 than a portion 34 other than the lower portion 33. Specifically, on the side of the jet nozzle 15, the portion 34 other than the lower portion 33 of the cutout 30 is subjected to surface treatment such as oxidation and nitriding, which facilitates the passage of the melted solder 12 through the lower portion 33 of the cutout 30.

Thus on the jet nozzle 15, the cutout 30 and the lower portion 33 of the cutout 30 constitute a passage of the melted solder 12. The provision of the passage can specify the flowing direction of the melted solder 12.

As a matter of course, like the jet nozzles of FIGS. 2A to 2C, a groove may be formed under the cutout 30 on the side of the jet nozzle 15. Conversely, also on the jet nozzles of FIGS. 2A to 2C, the groove under the cutout 30 may be replaced with a portion made of a material having higher wettability to the melted solder 12 than the other portion.

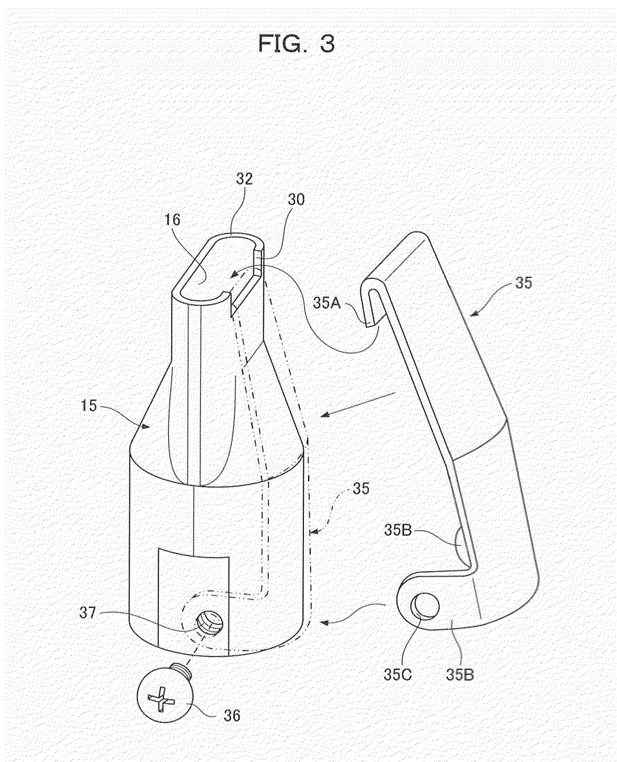

The following will describe still another example of the jet nozzle as shown in FIG. 3. On the jet nozzle 15 of FIG. 3, the oval opening 16 is provided substantially over the end face of the jet nozzle 15. The cutout 30 of the jet nozzle 15 is partially provided on one linear side of the end-face edge of the jet nozzle 15. On the jet nozzle 15, a portion other than the cutout 30 serves as the recovery wall 32 on the end-face edge of the jet nozzle 15.

On the jet nozzle 15, a detachable solder attracting member 35 is attached so as to cover the lower portion of the cutout 30 on a side of the jet nozzle 15. Virtual lines in FIG. 3 indicate the solder attracting member 35 attached to the jet nozzle 15.

The solder attracting member 35 is made of a material having higher wettability to the melted solder 12 than the side of the jet nozzle 15. Specifically, in the case where the side of the jet nozzle 15 has a nitrided stainless-steel surface, the solder attracting member 35 is made of materials such as pure iron containing at least 99% of iron components.

The upper end of the solder attracting member 35 has a bent portion 35A that is engaged with the cutout 30 of the jet nozzle 15. The lower end of the solder attracting member 35 has an arm 35B that holds the jet nozzle 15 from two sides thereof. The arm 35B of the solder attracting member 35 has drilled holes 35C. When the solder attracting member 35 is attached to the jet nozzle 15, the bent portion 35A of the solder attracting member 35 is engaged with the cutout 30 of the jet nozzle 15, and then a bolt 36 is screwed into screw holes 37 of the jet nozzle 15 through the holes 35C of the arm 35B of the solder attracting member 35. This structure can facilitate the replacement of the solder attracting member 35 and maintain the performance of the solder attracting member 35 after replacement.

The thickness of the bent portion 35A of the solder attracting member 35 is smaller than the depth of the cutout 30. Thus when the bent portion 35A of the solder attracting member 35 is engaged with the cutout 30, the cutout is left on the end face of the jet nozzle 15. The width of the cutout 30 can be set at, for example, about 5 mm and the depth of the cutout 30 can be set at, for example, at about 5 mm.

As has been discussed, on the jet nozzle 15 of FIG. 3, the cutout 30 formed on the end face of the jet nozzle 15 and the solder attracting member 35 attached to the jet nozzle 15 constitute a passage of the melted solder 12. The provision of the passage can specify the flowing direction of the melted solder 12.

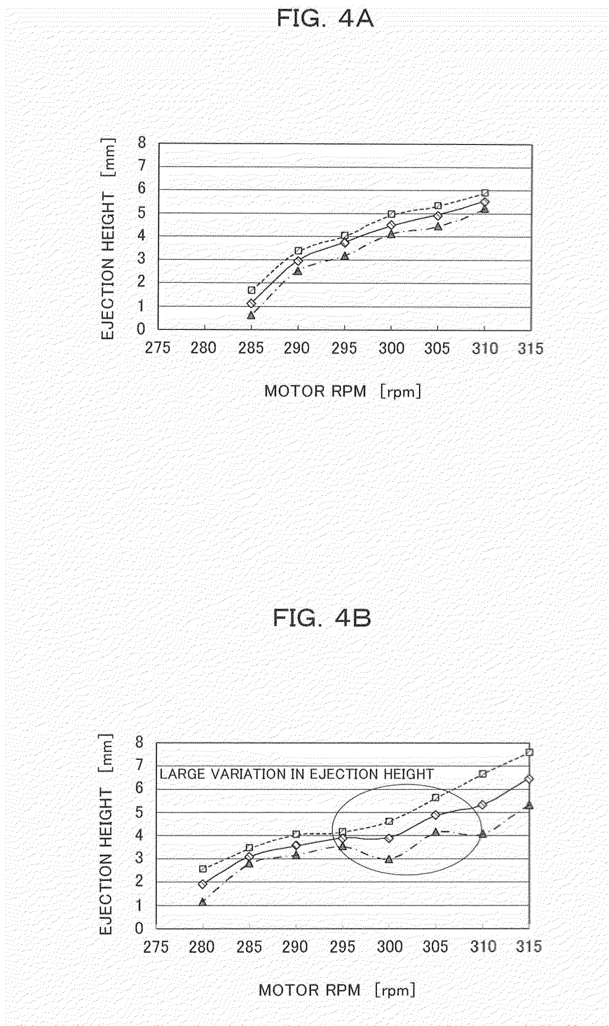

The following will describe a solder ejection height in the jet soldering device. FIG. 4A shows the measurement values of solder ejection heights when the jet nozzle 15 of the jet soldering device is used. In this case, the passage of melted solder is specified as in the foregoing examples. FIG. 4B shows, as a comparative example, the measurement values of solder ejection heights on a typical jet nozzle. In this case, the passage of melted solder is not specified. In either case, the opening of the jet nozzle is 8 mm in diameter.

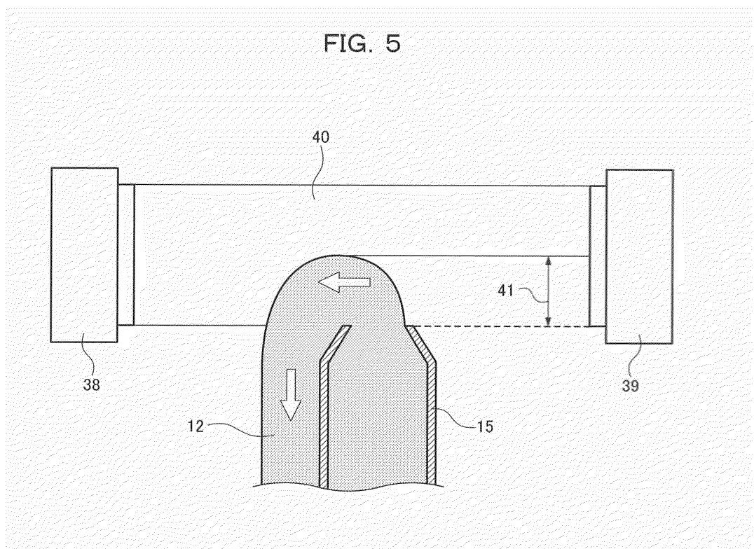

FIG. 5 shows an example of a measurement method of a solder ejection height. A solder election height can be measured by, for example, a displacement sensor including a projector 38 and a photo-receiver 39 as shown in FIG. 5. The projector 38 projects a parallel ray 40. The photo-receiver 39 receives the parallel ray 40 from the projector 38. In the case where the displacement sensor of FIG. 5 is used, a solder ejection height can be measured by detecting a dimension 41 of the parallel ray 40 that is interrupted by the melted solder 12 ejected from the end face of the jet nozzle.

The horizontal axes of graphs in FIGS. 4A and 4B each represent the number of revolutions of the propeller that pumps the melted solder to the jet nozzle. The vertical axes each represent an ejection height of the melted solder protruding from the end face of the jet nozzle. In each of the graphs of FIGS. 4A and 4B, data indicated by a central solid line represents the mean value of solder ejection heights when melted solder is ejected for about ten seconds. Moreover, data indicated by an upper broken line represents a maximum value and data indicated by a lower chain line represents a minimum value.

As shown in the graphs of FIGS. 4A and 4B, a solder ejection height tends to increase with the number of revolutions of the propeller. Moreover, the graph of FIG. 4A proves that the specified passage of melted solder stabilizes the solder ejection height such that a variation (a difference between the maximum value and the minimum value) in solder ejection height is about 0.5 mm at each rpm. In this way, the specified flowing direction of the melted solder can stabilize the solder ejection height. On the typical jet nozzle, the passage of melted solder is not specified. Thus the passage of the melted solder changes on a side of the jet nozzle when the melted solder is collected to the solder bath. As shown in FIG. 4B, a change of the passage results in large variations in solder ejection height.

Typically, the leads of the electronic component are protruded by 2.5 mm or less from the soldering surface. Thus a gap between the jet nozzle and the soldering surface has to be at least about 3 mm in consideration of an amount of warpage caused by soldering heat on the printed circuit board. Moreover, the melted solder ejected from the jet nozzle has to be high enough to cover the protrusions of the leads of the electronic component from the soldering surface. For this reason, the solder ejection height has to be stably kept at about 3.5 mm to 4 mm.

As shown in FIGS. 4A and 4B, the jet nozzle 15 having a specified passage of melted solder can achieve a larger usage range in which a required solder ejection height can be stably kept, as compared with the typical jet nozzle having no specified passages of melted solder. Thus the jet nozzle 15 having a specified passage of melted solder is more advantageous for soldering than the typical jet nozzle.

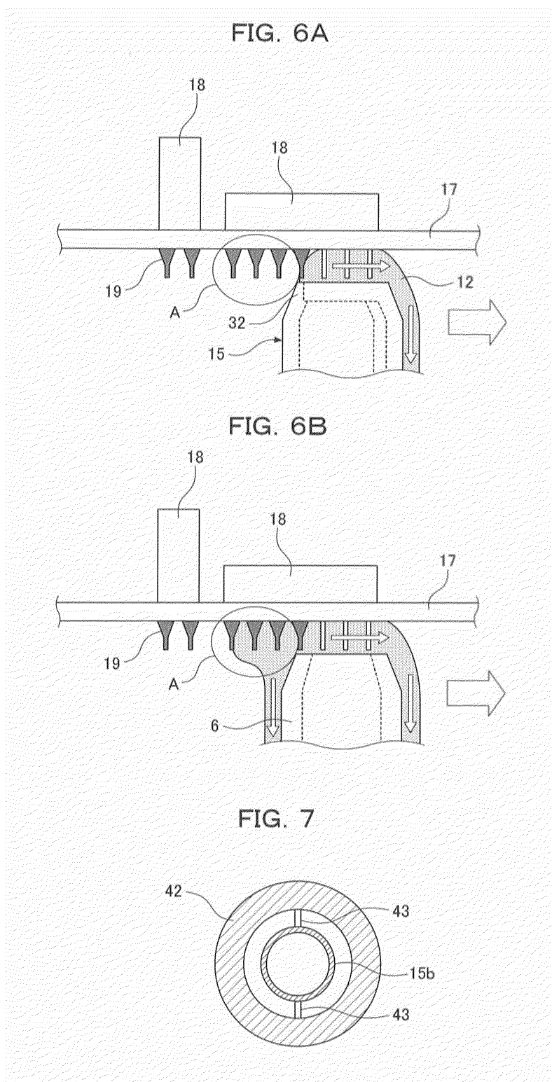

The following will describe the operation of the recovery wall 32 of the jet nozzle 15. FIG. 6A shows a soldering state in which drag soldering is performed using the jet nozzle 15 having a specified passage of melted solder. FIG. 6B shows, as a comparative example, a soldering state in which drag soldering is performed using a typical jet nozzle 6.

In the case of drag soldering using the typical jet nozzle 6, as shown in FIG. 6B, the melted solder 12 applied to a soldering point A may be pulled depending upon the surface tension of the melted solder 12 even after the jet nozzle 6 passes through the soldering point A, leaving an excessive amount of the melted solder 12 hanging from the soldering point A. In contrast to the typical jet nozzle, in the case where the recovery wall 32 is provided on the end face of the jet nozzle, as shown in FIG. 6A, an excessive amount of the melted solder 12 is removed by the recovery wall 32 when the jet nozzle 15 passes through the soldering point A. Thus it is possible to reduce the melted solder 12 left on the protrusions of the leads 19 of the electronic component from the soldering surface, thereby reducing the occurrence of faulty soldering such as solder bridging and solder protrusion. In order to remove an excessive amount of the melted solder 12 by the recovery wall 32 of the jet nozzle, the relative movement direction of the printed circuit board 17 and the jet nozzle 15 has to be set within a range of ±90° with respect to the specified flowing direction of the melted solder 12 on the jet nozzle 15.

The flowing direction of the melted solder 12 is specified and the relative movement direction of the printed circuit board 17 and the jet nozzle 15 is restricted with respect to the flowing direction, thereby reducing the occurrence of faulty soldering.

Referring to FIG. 1 again, the following will describe the nozzle rotating mechanism for rotating the jet nozzle 15 relative to the printed circuit board 17. As has been discussed, in order to remove an excessive amount of the melted solder 12 by the recovery wall 32 of the jet nozzle, the relative movement direction of the printed circuit board 17 and the jet nozzle 15 has to be set within a range of ±90° with respect to the specified flowing direction of the melted solder 12 on the jet nozzle 15. In order to reliably and easily satisfy the condition, the nozzle rotating mechanism for rotating the jet nozzle 15 relative to the printed circuit board 17 is provided in the present embodiment.

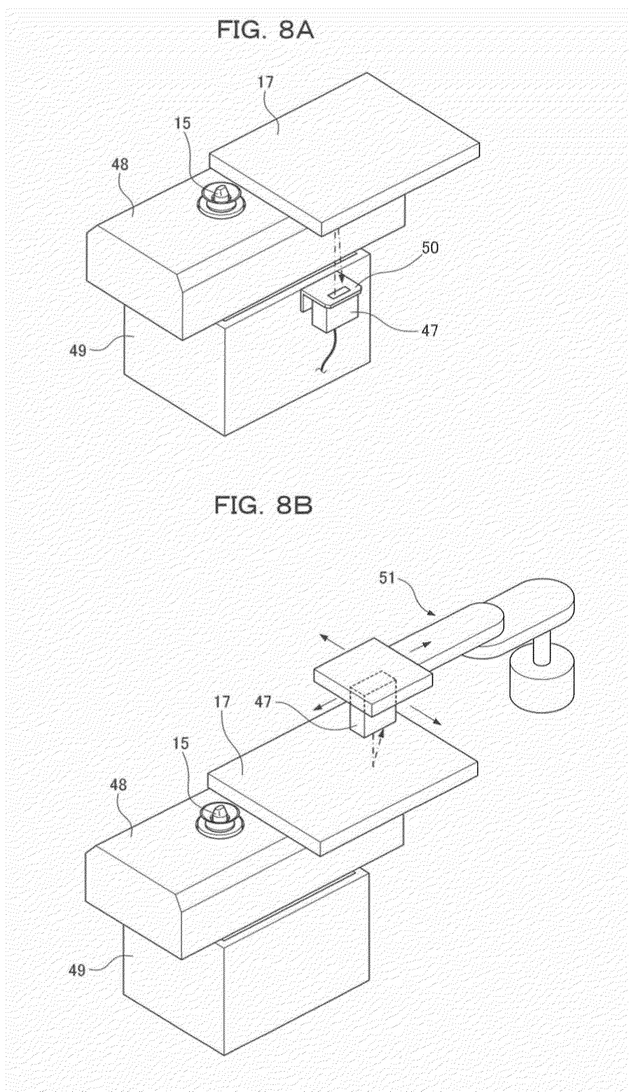

As shown in FIG. 1, the jet nozzle 15 includes two upper and lower components. A lower nozzle 15a is connected and fixed to the solder feeding path 14 in the solder bath 11. An upper nozzle 15b is fastened, as shown in FIG. 7, to the solder receiving wall 42 via fastener members 43. To be specific, the solder receiving wall 42 has a through hole where the upper nozzle 15b is inserted. The fastener members 43 keep a fixed clearance between the inner surface of the solder receiving wall 42 and the outer surface of the upper nozzle 15b.

The solder receiving wall 42 is rotationally supported by a rotational support bearing (not shown). Moreover, the rotational support bearing keeps constant the position of the solder receiving wall 42 in the height direction (Z direction) and the rotation center position of the solder receiving wall 42, thereby also keeping constant the position of the upper nozzle 15b in the height direction and the rotation center position of the upper nozzle 15b.

To the rotationally supported solder receiving wall 42, a drive force is applied from a drive unit 44, which is disposed outside the solder bath 11, via a gear 45 and a gear 46. The drive force transmitted from the outside of the solder receiving wall 42 rotates the solder receiving wall 42 and the upper nozzle 15b.

The lower end face of the upper nozzle 15b and the upper end face of the lower nozzle 15a are opposed to each other with a clearance provided between the lower end face and the upper end face. The width of the clearance is set so as not to allow the melted solder 12 to leak from the clearance because of the surface tension. For example, the width of the clearance can be selected from a range of about 0.05 mm to 0.1 mm.

The rotational support bearing for determining the position of the solder receiving wall 42 in the height direction and the rotation center position of the solder receiving wall 42 may be replaced with a rotational support bearing for determining only the rotation center position of the solder receiving wall 42. In this case, a stopper is provided which receives the self weights of the solder receiving wall 42 and the upper nozzle 15b to prevent the lower end face of the upper nozzle 15b and the upper end face of the lower nozzle 15a from coming into contact with each other. As has been discussed, the width of a clearance provided between the lower end face of the upper nozzle 15b and the upper end face of the lower nozzle 15a by the stopper is set so as not to allow the melted solder 12 to leak from the clearance because of the surface tension.

The support member that rotationally supports the solder receiving wall 42 is not limited to a rotational support bearing.

The jet nozzle 15 is rotated in this explanation. Alternatively, a rotating mechanism may be provided on the tank moving mechanism that moves the solder bath 11. With this configuration, the jet nozzle 15 can be rotated by a rotation of the solder bath 11. Furthermore, a substrate drive unit including a holding member for holding the printed circuit board may be provided to rotate the printed circuit board. However, the jet nozzle 15 is preferably rotated to easily optimize the orientation of the jet nozzle 15 as compared with rotations of the solder bath 11 and the printed circuit board 17. Thus high-speed soldering can be achieved.

The following will describe a nozzle end height measuring device. When the jet soldering device is operated, the temperature of the solder bath 11 is raised and the jet nozzle 15 expands according to the temperature rise. The expansion changes the height of the end of the jet nozzle 15, leading to fluctuations of a gap between the printed circuit board 17 and the end of the jet nozzle 15. For this reason, the jet soldering device includes the nozzle end height measuring device that measures the height of the end of the jet nozzle 15.

The nozzle end height measuring device may be, for example, the displacement sensor of FIG. 5. The displacement sensor includes the projector 38 for projecting a parallel ray and the photo-receiver 39 for receiving the parallel ray from the projector 38. In the case where the displacement sensor is used, the height of the end of the jet nozzle 15 can be measured based on the dimension of the parallel ray that is interrupted by the jet nozzle 15. The projector 38 and the photo-receiver 39 may be attached to, for example, transport rails for transporting the printed circuit board 17 above the solder bath 11.

In the jet soldering device, the nozzle end height measuring device measures the height of the end of the jet nozzle 15 when the jet soldering device is operated, and the measured height is reflected in a soldering program. This configuration can rotate the propeller 13 at an rpm corresponding to an expansion of the jet nozzle 15, adjusting the solder ejection height to a desired height. Thus when the jet nozzle 15 is attached to the jet soldering device, it is not necessary to adjust the position of the end of the jet nozzle 15 in the height direction in consideration of an expansion of the jet nozzle 15, reducing the load of an operator.

The substrate warpage measuring device will be described below.

In soldering, a liquid flux for removing an oxide film is applied to the electrodes of the printed circuit board 17 and the leads 19 of the electronic component immediately before the melted solder 12 is brought into contact with the printed circuit board 17. The printed circuit board 17 is then heated (pre-heated) to dry the applied liquid flux. The heated printed circuit board 17 is supported only on the ends by the transport rails, so that the printed circuit board 17 is warped by the self weight of the printed circuit board 17. Moreover, in soldering, the melted solder 12 heated to about 300° is locally applied to the printed circuit board 17 and the melted solder 12 may warp the circuit board.

According to an experiment, as has been discussed, even in the case where the flowing direction of the melted solder is specified and the recovery wall 32 is provided, the recovery wall 32 may not fully collect an excessive amount of the melted solder 12 when a gap is, for example, about 0.5 mm or more between the jet nozzle 15 and the ends of the leads 19 of the electronic component, the leads 19 protruding from the soldering surface.

In the case where the printed circuit board 17 is warped to the jet nozzle 15 and the warp is larger than the gap between the ends of the leads 19 of the electronic component and the jet nozzle 15, the end of the jet nozzle 15 and the ends of the leads 19 of the electronic component interfere with each other. The interference leads to bending or faulty soldering on the ends of the leads 19.

For this reason, the jet soldering device includes the substrate warpage measuring device for measuring an amount of warpage of the printed circuit board 17. In the present embodiment, the substrate warpage measuring device is a noncontact sensor that measures a distance by a laser.

In the case where the noncontact sensor is used, as shown in FIG. 8A, a noncontact sensor 47 may be disposed below the printed circuit board 17 (solder attachment surface). Alternatively, as shown in FIG. 8B, the noncontact sensor 47 may be disposed above the printed circuit board 17 (the opposite surface from the solder attachment surface). FIGS. 8A and 8B show the jet soldering device with a cover 48 and a cabinet 49. The cover 48 covers the rotating mechanism of the jet nozzle 15 and the driving mechanism of the propeller 3. The cabinet 49 accommodates the solder bath 11. On the setting table 26 of FIG. 1, the cabinet 49 accommodating the solder bath 11 is placed.

In the case where the noncontact sensor 47 is disposed below the printed circuit board 17, the noncontact sensor 47 is preferably set away from the solder bath 11, since an ambient temperature around the solder bath 11 reaches 80° to 100°. For example, as shown in FIG. 8A, the noncontact sensor 47 may be connected via a bracket 50 to the cabinet 49 accommodating the solder bath 11. With this configuration, from below the printed circuit board 17, a distance between the noncontact sensor 47 and the printed circuit board 17 can be measured at any position on the printed circuit board 17. Thus according to the measured distance, the solder bath 11 is moved in the Z direction (vertical direction) by the tank moving mechanism, so that a height from the end of the jet nozzle 15 to the printed circuit board 17 can be adjusted. Hence, the gap between the ends of the leads 19 of the electronic component and the jet nozzle 15 can be kept at less than 0.5 mm.

In the case where the noncontact sensor 47 is disposed above the printed circuit board 17, as shown in FIG. 8B, the noncontact sensor 47 may be moved in X-Y direction by, for example, a robot 51 having a holding mechanism for holding the noncontact sensor 47. With this configuration, when the melted solder 12 is locally brought into contact with the printed circuit board 17, the sensor 47 is moved to the contact position (soldering position) of the melted solder 12 and a distance between the noncontact sensor 47 and the printed circuit board 17 can be measured at the soldering position. Thus according to the measured distance, the solder bath 11 is moved in the Z direction (vertical direction) by the tank moving mechanism, so that a height from the end of the jet nozzle 15 to the printed circuit board 17 can be adjusted. This configuration can adjust the position of the solder bath 11 in the Z direction in real time, thereby more precisely adjusting a height from the end of the jet nozzle 15 to the printed circuit board 17. Hence, the gap between the ends of the leads 19 of the electronic component and the jet nozzle 15 can be reliably kept at less than 0.5 mm.

The position of the substrate warpage measuring device is not limited to a position above or below the printed circuit board 17. For example, the substrate warpage measuring device may be connected to a pin holding member that holds a positioning pin for positioning the printed circuit board 17. In the case where the substrate warpage measuring device is connected to the pin holding member, an amount of warpage is measured only on two ends of the printed circuit board 17. The substrate warpage measuring device is not limited to a noncontact sensor and may be a contact sensor such as a stylus.

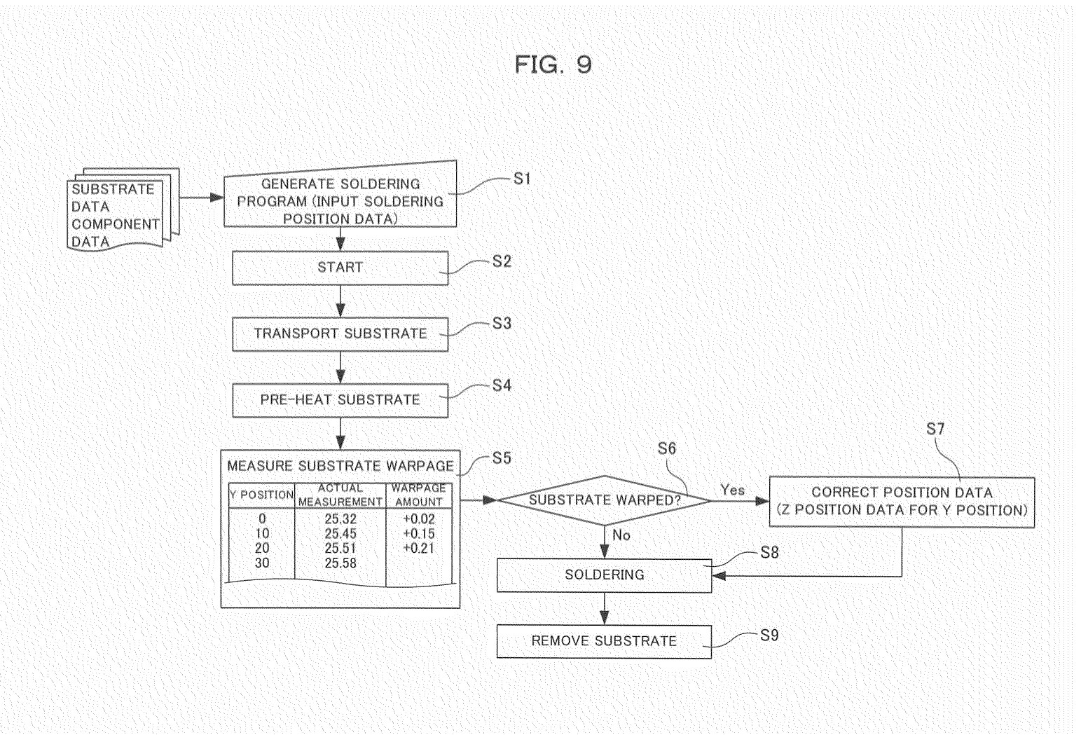

Referring to FIG. 9, a process flow of the jet soldering device will be described below. FIG. 9 shows an example of the process flow of the jet soldering device including the substrate warpage measuring device that is disposed below the printed circuit board 17 as shown in FIG. 8A.

First, an operator inputs soldering position data (X, Y), Z position data (position in the height direction) of the jet nozzle 15 at each soldering position (X, Y), and movement data of the solder bath 11 to the control unit 27 based on substrate data and component data. The control unit 27 generates a soldering program based on the inputted data (step S1). The Z position of the jet nozzle 15 is determined in consideration of the dimensions of the protrusions of the leads 19 of the electronic component from the printed circuit board 17.

Next, the operator operates the jet soldering device (step S2). The control unit 27 controls the operations of the overall jet soldering device based on the generated soldering program.

When the printed circuit board 17 is transported to the jet soldering device (step S3), the transported printed circuit board 17 is heated by pre-heating immediately before soldering (step S4). Since the heating causes warpage on the printed circuit board 17, an amount of warpage is measured from below the printed circuit board 17 by the substrate warpage measuring device after the pre-heating (step S5). For example, an amount of warpage may be measured at intervals of 10 mm in the Y direction.

The control unit 27 decides whether the printed circuit board 17 has been warped or not based on the measurement results of warpage amounts of the printed circuit board 17 (step S6). In the present embodiment, it is decided whether the gap between the leads 19 of the electronic component and the jet nozzle 15 is at least 0.5 mm or not based on the measurement results of distances between the noncontact sensor 47 and the printed circuit board 17. Furthermore, it is decided whether or not the gap between the leads 19 of the electronic component and the jet nozzle 15 allows the leads 19 of the electronic component to interfere with the jet nozzle 15.

In the case where the printed circuit board 17 is warped, the control unit 27 reflects the measurement result of warpage amount of the printed circuit board 17 in the Z position data of the jet nozzle 15 (step S7). After that, soldering is performed (step S8). In the case where the printed circuit board 17 is not warped, soldering is performed without correcting the Z position data of the jet nozzle 15 (step S8). After the soldering, the printed circuit board 17 is transported from the jet soldering device (step S9).

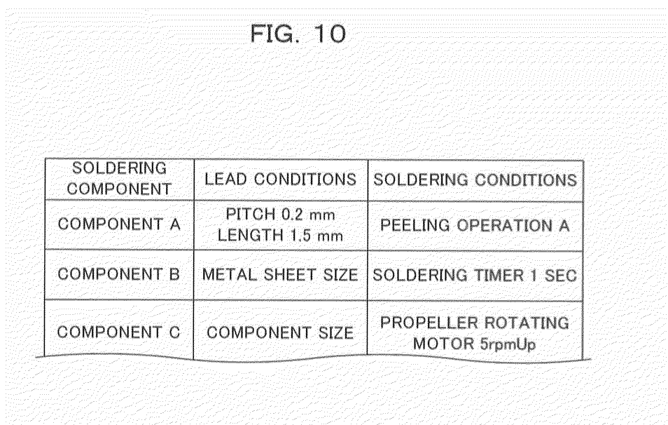

Referring to FIG. 10, the following will describe the library used for the jet soldering device. FIG. 10 shows an example of the library. The library is updatable information in which soldering conditions are registered for each soldering component type. The operator can generate the soldering program by using the information registered in the library. Thus the library can considerably reduce a time period for generating the soldering program.

The library is stored in the storage part 28 of the control unit 27. The library can be called up when the operator generates the soldering program. Moreover, highly common soldering conditions for soldering of various printed circuit boards can be registered in the library.

For example, in the case of soldering on a soldering component having 1.5-mm leads spaced at 0.2 mm, drag soldering can be performed on the consecutively arranged leads (soldering points) while the relative movement speed of the jet nozzle is set at 10 mm/sec. Thus by registering information about the drag soldering operation in the library as the soldering condition of soldering component A, the operator can generate a soldering program by using the information from the library in the case where a component similar to the soldering component A is soldered to the printed circuit board of another model. For example, only by selecting the soldering component A, the drag soldering operation can be incorporated into the soldering program.

As shown in FIG. 10, a removing operation (peeling operation) of the melted solder is also registered as a soldering condition of the soldering component A. For example, a peeling operation is registered in which the jet nozzle 15 is moved relative to the printed circuit board 17 by 5 mm in a drag soldering direction and by 5 mm in a downward direction, that is, downward at 45° from the end point of drag soldering; meanwhile, the cutout 30 of the jet nozzle 15 is kept oriented in the drag soldering direction before the peeling operation. Thus only by selecting the soldering component A, the peeling operation can be incorporated into the soldering program.

Furthermore, the library is effective for point soldering as well as drag soldering. For example, as shown in FIG. 10, as a soldering condition for a metal sheet (soldering component B) having a large thermal capacity, an operation can be registered in which a one-second timer is set after the melted solder comes into contact with a soldering point. Additionally, as a soldering condition for soldering component C having a large thermal capacity, a setting can be registered in which the number of revolutions of the propeller 13 for pumping the melted solder to the jet nozzle 15 is raised to increase the supply of the melted solder to the jet nozzle 15.

In this library, the number of registrations can be increased by a user and thus soldering conditions can be accumulated as know-how.

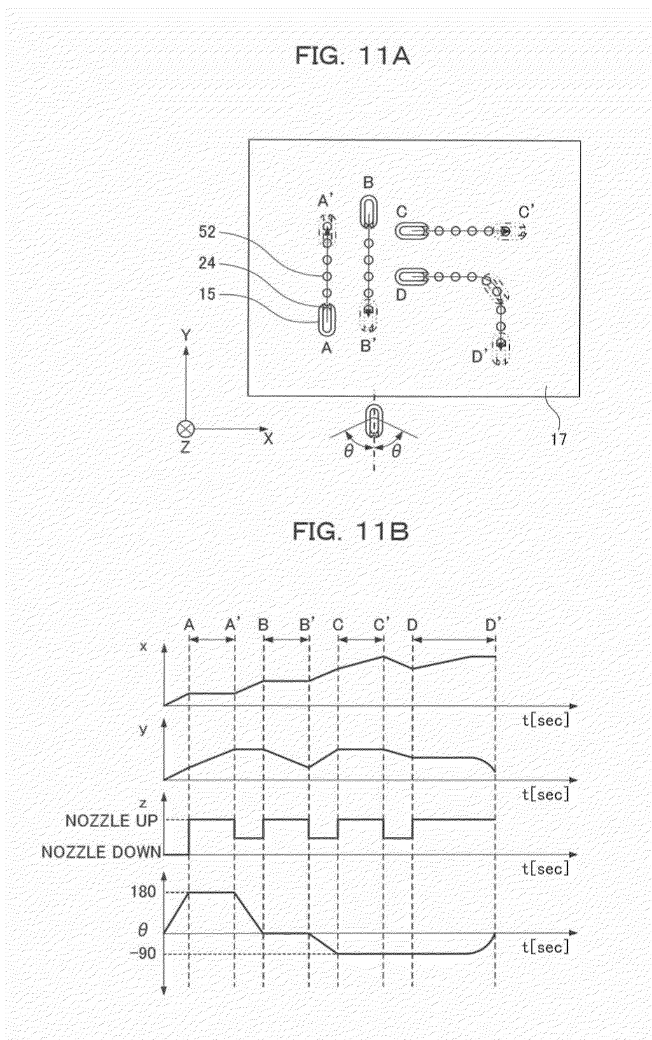

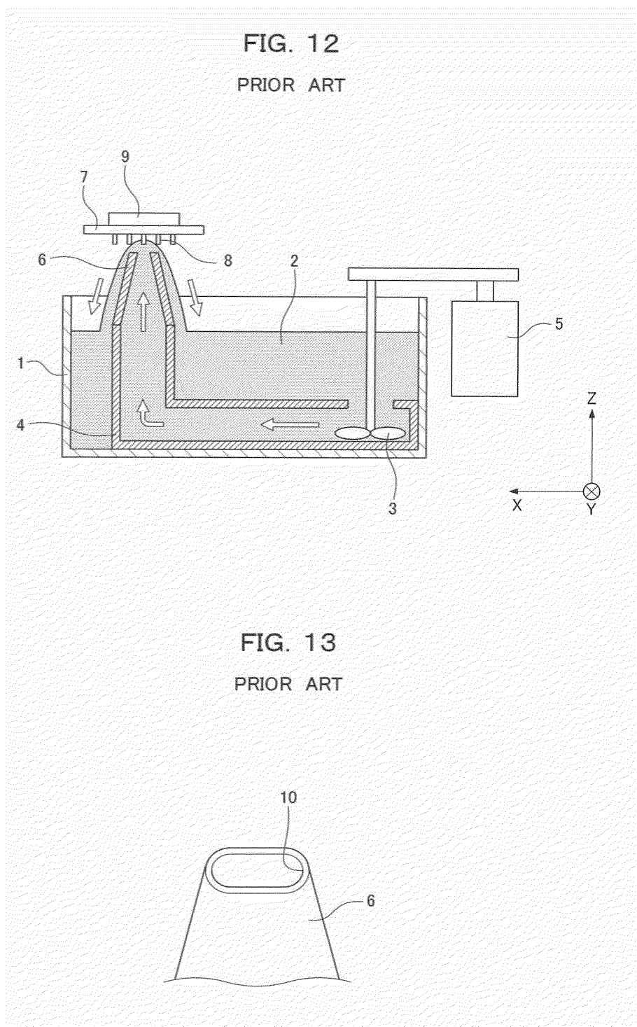

The following will describe an example of the operation of the jet nozzle in the jet soldering device. FIG. 11A shows the moving directions of the jet nozzle 15 relative to the printed circuit board 17 and the orientations of the cutout 30 provided on the jet nozzle 15. FIG. 11B shows X position, Y position, and Z position of the jet nozzle 15 and angle θ of the cutout 30 provided on the jet nozzle 15. The angle θ (orientation) of the cutout 30 is 0° when the cutout 30 is oriented downward in the plane of FIGS. 11A and 11B. The melted solder 12 flows according to the orientation of the cutout 30.

The following will describe the case where the solder bath 11 is moved so as to move the jet nozzle 15 in the flowing direction of the melted solder 12 from the end face of the jet nozzle 15, that is, according to the orientation of the cutout 30.

First, when the jet nozzle 15 is moved to the position of soldering start point A, the jet nozzle 15 is moved in a rotating manner. The jet nozzle 15 is rotated 180° by the rotation so as to orient the cutout 30 from the soldering start point A to Soldering end position A′. When the jet nozzle 15 is moved to the position of the soldering start point A, the Z position of the jet nozzle 15 is kept at a lower position where the melted solder 12 ejected from the jet nozzle 15 is not brought into contact with the printed circuit board 17.

When the jet nozzle 15 has been moved to the position of the soldering start point A, the jet nozzle 15 is moved up by a predetermined distance in the Z direction and then soldering is started. When the jet nozzle 15 has been moved to the soldering end position A′ from the soldering start point A, the jet nozzle 15 is moved down by a predetermined distance to terminate soldering A.

Next, the jet nozzle 15 is moved to the position of soldering start point B in a rotating manner. The jet nozzle 15 is rotated 180° by the rotation so as to orient the cutout 30 from the soldering start point B to soldering end position B′.

When the jet nozzle 15 has been moved to the position of the soldering start point B, the jet nozzle 15 is moved up again to start soldering. When the jet nozzle 15 has been moved from the soldering start point B to the soldering end position B′, the jet nozzle 15 is moved down by a predetermined distance to terminate soldering B.

Soldering C and D are performed in a similar manner. In soldering D, however, the jet nozzle 15 is moved while being rotated along the array of soldering points 52 in the middle of soldering. The jet nozzle 15 is rotated thus in the middle of soldering, so that the jet nozzle 15 can be always moved according to the orientation of the cutout 30.

### INDUSTRIAL APPLICABILITY

A jet soldering device and a soldering method according to the present invention can reduce the occurrence of faulty soldering such as solder bridging and solder protrusion. For example, the jet soldering device and the soldering method are applicable to soldering of printed circuit boards.

1. A jet soldering device comprising:
a solder bath containing melted solder;
a jet nozzle that includes a side, an end face for ejecting the melted solder, a cutout provided on the end face to allow passage of the melted solder from the end face, and a recovery wall provided on the end face to partially collect the melted solder having been applied to at least one of a soldering object and a soldering component to be soldered to the soldering object;
a solder feeding mechanism that feeds the melted solder contained in the solder bath to the jet nozzle;
a tank moving mechanism that moves the solder bath;
a solder receiving wall that surrounds the jet nozzle with a predetermined clearance and is connected to the jet nozzle; and
a rotating mechanism that transmits a drive force to the solder receiving wall from outside of the solder receiving wall to rotate the solder receiving wall and the jet nozzle connected to the solder receiving wall.

2. The jet soldering device according to claim 1, wherein the tank moving mechanism moves the solder bath or the rotating mechanism rotates the jet nozzle while the tank moving mechanism moves the solder bath, in order to set a relative movement direction of the jet nozzle and the soldering object within a range of ±90° with respect to a flowing direction of the melted solder from the end face of the jet nozzle.

3. The jet soldering device according to claim 1, wherein the side of the jet nozzle includes a groove that is provided under the cutout as a passage of the melted solder.

4. The jet soldering device according to claim 1, wherein the side of the jet nozzle has a portion under the cutout of the jet nozzle such that the portion is made of a material having higher wettability to the melted solder than other parts of the side.

5. The jet soldering device according to claim 1, further comprising a solder attracting member covering a portion under the cutout on the side of the jet nozzle, the solder attracting member having a surface made of a material having higher wettability to the melted solder than the side of the jet nozzle.

6. The jet soldering device according to claim 1, wherein the end face of the jet nozzle includes a groove provided as a passage of the melted solder.

7. The jet soldering device according to claim 1, further comprising a measuring device that measures an amount of warpage of the soldering object,
wherein the tank moving mechanism adjusts a height from an end of the jet nozzle to the soldering object according to the amount of warpage measured by the measuring device.

8. The jet soldering device according to claim 1, further comprising an updatable library in which soldering conditions are registered for each soldering component type.

9. A soldering method of feeding melted solder from a solder bath to a jet nozzle and locally bringing a soldering object into contact with the melted solder ejected from an end face of the jet nozzle,
the jet nozzle including a side, the end face for ejecting the melted solder, a cutout provided on the end face to allow passage of the melted solder from the end face, and a recovery wall provided on the end face to partially collect the melted solder having been applied to at least one of the soldering object and a soldering component to be soldered to the soldering object,
in soldering on the soldering object and the soldering component, the soldering method comprising:
moving the solder bath by a tank moving mechanism or rotating the jet nozzle by a rotating mechanism while the tank moving mechanism moves the solder bath, in order to set a relative movement direction of the jet nozzle and the soldering object within a range of ±90° with respect to a flowing direction of the melted solder from the end face of the jet nozzle.

10. The soldering method according to claim 9, wherein in soldering on the soldering object and the soldering component, the tank moving mechanism moves the solder bath or the rotating mechanism rotates the jet nozzle while the tank moving mechanism moves the solder bath, in order to move the jet nozzle in the flowing direction of the melted solder from the end face of the jet nozzle.
